(19) United States
(12) Patent Application Publication
(10) Pub. No.: US 2025/0103967 A1
(43) Pub. Date: Mar. 27, 2025

(54) SYSTEM AND ENSEMBLE METHOD FOR UNBIASED SYNTHETIC TIME SERIES GENERATION LEVERAGING CONTRASTIVE LEARNING BETWEEN GENERATIVE MODELING AND PROBABILISTIC MODELING

(71) Applicant: Dell Products L.P., Round Rock, TX (US)

(72) Inventors: Srishti Gupta, Rohini (IN); Kuruba Ajay Kumar, Anantapur (IN); Sailendu Kumar Patra, Bangalore (IN); Saurabh Jha, Austin, TX (US)

(21) Appl. No.: 18/475,120

(22) Filed: Sep. 26, 2023

(51) Int. Cl. G06N 20/20

(52) U.S. Cl. CPC G06N 20/20

(57) ABSTRACT

One example method includes collecting real data, creating synthetic data by modeling the real data, augmenting the real data and the synthetic data, applying a loss function to minimize an error between the real data and the synthetic data, adding noise to the synthetic data to create finalized synthetic data, and generating a forecast based on the finalized synthetic data. The forecast may be used as a basis to guide the performance of a resource allocation process.

### FIELD OF THE INVENTION

Embodiments of the present invention generally relate to the use of time series data for generating forecasts. More particularly, at least some embodiments of the invention relate to systems, hardware, software, computer-readable media, and methods, for generation of synthetic time series data for inclusion in a dataset that may be used to support forecasting.

### BACKGROUND

Data point variances measured and compared from year to year can reveal patterns, such as seasonal fluctuation patterns for example, that can serve as the basis for the creation of forecasts concerning future behavior and events. However, it is often the case that only a portion of the entire dataset has the trend and seasonality component that is of interest for the development of forecasts. Moreover, that component may only be available for a short period of time. As a result, any forecasts generated using the dataset may be based on only a relatively small amount of time series data and, as such, the accuracy of the forecasts may suffer.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIGS. 1a and 1b disclose aspects of an ensemble solution architecture according to one embodiment.

FIG. 2 discloses aspects of noise addition block for non-seasonal data according to one embodiment.

FIG. 3 discloses a method according to one embodiment.

FIG. 4 discloses visual plots for validating real vs. synthetic data according to one embodiment.

FIG. 5 discloses a computing entity configured and operable to perform any of the disclosed methods, processes, and operations.

### DETAILED DESCRIPTION OF SOME EXAMPLE EMBODIMENTS

Embodiments of the present invention generally relate to the use of time series data for generating forecasts. More particularly, at least some embodiments of the invention relate to systems, hardware, software, computer-readable media, and methods, for generation of synthetic time series data for inclusion in a dataset that may be used to support forecasting.

In general, one embodiment of the invention comprises an approach to augment time series data using a hybrid approach of probabilistic modeling and generative modeling, leveraging contrastive learning between the two types of modeling, and ensuring that the synthesized time series samples are bias-free and noise-free by using custom loss function. One particular example embodiment may be employed in a context that involves the use of time series data to forecast customer orders for one or more products. However, the scope of the invention is not limited to any particular application.

In more detail, an embodiment of the invention may leverage a contrastive learning approach that minimizes the loss between two models, such as probabilistic modeling and generative modeling. This approach may ensure that the augmented data synthesized is bias-free and noise-free. A denoising technique may be employed in the architecture to ensure that corrupted/noisy data samples are not diffused into the target time series data. An embodiment may implement a noise addition block to add noise in non-seasonal data to make sure the target series is close to the real series.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that sparse time series data may be supplemented with high-fidelity synthetic data to form a dataset that may be used as a basis for the generation of reliable forecasts. An embodiment of the invention may generate reliable forecasts notwithstanding the limited availability of seasonal data needed to generate the forecasts. Various other advantages of one or more embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment of the Invention

Quantitative and qualitative methodologies for forecasting may help organizations to develop business goals and objectives. Business forecasts can be based on historical data patterns that are used to predict future market behavior. The time series method of forecasting is one data analysis tool that measures historical data points to forecast future conditions and events. The goal of the time series method is to identify meaningful characteristics in the data that can be used in making statements about future outcomes. Accurate forecasting of orders is important to understand and manage the inventory, improving customer satisfaction rate and thereby improving the business. Forecasting orders at a granular level may be important to understand the business at various business segments. Forecasting orders at a granular level has applications in various industries such as, for example, electricity consumption planning, manufacturing production planning, energy and smart grid management, sensor network monitoring and countless of applications in economics/finance.

In more detail, an organization may need to process orders, such as for products or services for example, that are received from customers. In any given day, tens of thousands of orders from around the world may be received by an organization. These orders may contain multiple attachments including purchase order and other files which have order details such as shipping address, order quantity, and mode of payment. Some orders may be processed in a frictionless way, that is, automatically. However, for those orders which does not get processed automatically, the details may be processed manually and entered into a business tool by an agent. The number of agents required to process the orders may be directly proportional to the number of orders received on that day.

Once a customer purchases a product, for example, the organization may aim to provide the best possible customer support. Thus, part of the organization may be is responsible for addressing the queries that the customer might have once they have booked the order. The queries that might be received could be about the status of the order, change in the order quantity, ETA (estimated time of arrival) of order, change in shipping address, or a complaint about a defective order, for example. Also, these queries may be received from variety of channels such as email, chat, or voice call, for example. As these order related queries are received once the order is booked, the number of agents needed to handle these queries is proportional to the number of orders booked by clients.

Data point variances measured and compared from year to year, for example, can reveal seasonal fluctuation patterns, regarding customer orders in this example, that can serve as the basis for the generation of forecasts of future customer orders. However the entire dataset might not have that seasonality component. That is, it may be the case that only a fraction of the data has a trend and seasonality component, and the data may only be available for a short period of time. Thus, an example embodiment may comprise an approach for creating generalized time series data, that is, synthetic data that was not part of the original dataset, based on contrastive learning, namely, an ensembled technique of probabilistic and generative models with minimized cross-entropy loss. An embodiment may implement noise addition block to add noise in non-seasonal data to make sure the target series is close to the real series.

Order forecasting, for example, may have strategic implications for the business operations of an organization. For example, the purpose of capacity planning is to make better inventory management and provide quality services to the customers. It is also equally important that businesses do not employ inaccurate inventory as it is expensive to store excess inventory, and a lack of adequate inventory may prevent fulfillment of customer orders, leading to loss of customer satisfaction, and loss of sales. Hence, orders forecasting plays a very important role in business operations.

### B. Overview of an Example Embodiment of the Invention

It is noted that while reference is made herein to the generation of synthetic data for use in creating forecasts of future customer orders for products and/or services, the scope of the invention is not limited to the customer orders domain and, instead, extends more generally to any application where a dataset intended to be used for a forecasting purpose may need additional data in order to support the generation of accurate forecasts. As such, the reference herein to customer order forecasting is provided only by way of example and is not intended to limit the scope of the invention in any way.

Orders forecasting is a regular activity that may be carried out across multiple business units of an organization. One purpose of capacity planning is to make sure of enough inventory management to provide better quality services to the customers.

To provide quality customer support, an organization may hold itself accountable to various Key Performance Indicators (KPIs) which needs to be met for each customer. For example, every email received by the organization must be responded back to customer within a set period of time, such as 4 hours, and every single customer call must be picked up within a set period of time, such as 2 min, for example. This means that business should have enough staff, otherwise the business will not be able to meet these KPIs. So, orders forecasting is important to better manage and meet all business KPIs and business agreements with customer.

When a customer orders a product from an organization, there could be issues related to the order. For example, the customer might want to cancel the order, or want to know the status of product, or a change in product, for example. In certain cases, the product might get delayed, or damaged during delivery. So, the customer may contact the organization for support for any kind of issue or a question regarding the order itself, and the business tries to find a solution for the customer. An organization can make predictions, that is, generate forecasts, around how many customer orders might be expected to be placed in the coming quarters and how much manpower would be required to support those order. The purpose of capacity planning is to make better inventory management decisions, and to provide quality services to the customers. It is also equally important that businesses do not employ inaccurate inventory as it is expensive. Hence, orders forecasting may play an important role in business operations.

Often, the data available, for forecasting, at the organization level can be noisy and recorded for a short span of time which might lead to generalization problems. Furthermore, building complex forecasting models on small datasets might affect the accuracy. Thus, an embodiment of the invention may leverage contrastive learning that minimizes the loss between two models viz. using probabilistic and generative modeling. This approach may help to ensure the augmented data that has been synthesized is bias-free and noise-free. In an embodiment, a denoising technique is employed in the architecture to ensure that corrupted/noisy data samples are not diffused in the target time series data. Also, an embodiment may implement noise addition block to add noise in non-seasonal data to make sure the target series is close to the real series.

### C. Detailed Description of Aspects of an Example Embodiment of the Invention

### C.1 Controlled Synthetic Data Creation

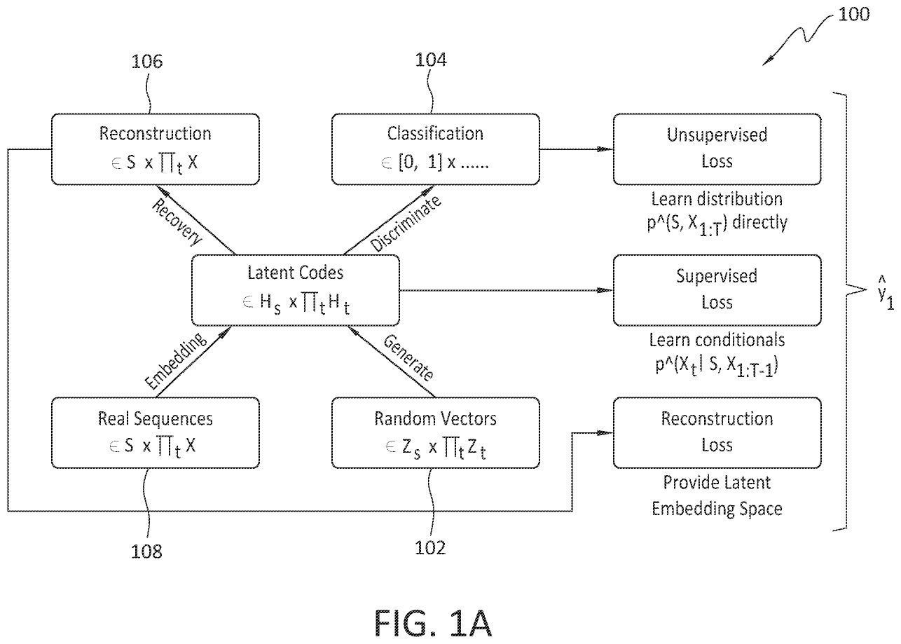

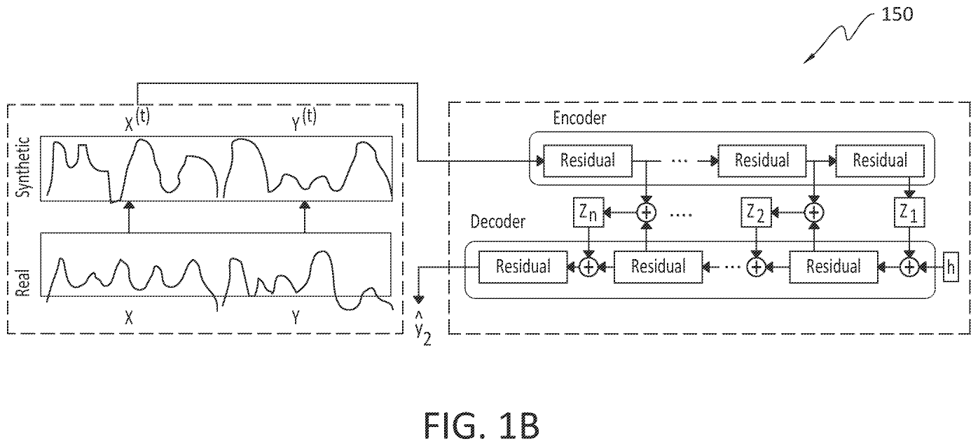

As discussed previously herein, an embodiment of the invention may be directed to controlled synthetic data creation using generative adversarial networks (GAN) and diffused probabilistic model using custom loss function and contrastive learning. An example GAN is referenced at 100 in FIG. 1a, and an example probabilistic model is referenced at 150 in FIG. 1b. In general, FIGS. 1a and 1b disclose component function and objectives to create synthetic data preserving the temporal dynamics. FIG. 1a depicts the GAN(s) 100 and FIG. 1b depicts the probabilistic model 150.

With reference first to the GAN 100, in order to create synthetic data that mimics the real data, while keeping temporal dynamics intact, an embodiment of the invention may use a generative adversarial network, such as the GAN 100. The architecture of the example GAN 100 may comprise four networks that each play a respective role in a data modeling process, namely, a generator 102, a discriminator 104, a recovery model 106, and an embedder model 108.

An embodiment of the invention may use a supervised loss, that is, the model is encouraged to capture time conditional distribution within the data by using the original data as a supervision. Also, the solution architecture may comprise an embedding network that is responsible to reduce the adversarial learning space dimensionality. The embedding and recovery functions provide mappings between features and latent space, allowing the adversarial network to learn the underlying temporal dynamics of the data via lower-dimensional representations. By using a latent space to reduce the dimensionality of the dataset, that is, the number of features in the dataset, to only the most relevant features, an embodiment may be able to generate better results in terms of forecast accuracy.

In more detail, let H_{S}, H_{X} denote the latent vector spaces corresponding to feature spaces S, X. Then the embedding function e: S×Πₜ X→H_{S}×Πₜ H_{X} takes static and temporal, or time-based, features to their latent codes. That is, temporal features may change their values over time, while static features, such as a geographic location for example, do not.

In the opposite direction, the recovery function r: HS×Πₜ H_{X}→S×ΠₜX takes static and temporal codes back to their feature representations implemented through a feedforward network at each step. Instead of producing synthetic output directly in feature space, the generator 102 first outputs into the embedding space. Let Z_{S}, Z_{X} denote vector spaces over which known distributions are defined, and from which random vectors are drawn as input for generating into H_{S}, H_{X}. Then the generating function g: Z_{S}×Πₜ Z_{X}→H_{S}×Πₜ H_{X} takes a tuple of static and temporal random vectors to synthetic latent codes. Finally, the discriminator 104 also operates from the embedding space. The discrimination function, d: H_{S}×Πₜ H_{X}→[0, 1]×Πₜ [0, 1] receives the static and temporal codes, returning classifications as real, or synthetic.

With reference now to the example probabilistic model 150 of FIG. 1b, a coupled forward process may be developed to augment the input series and target series synchronously. This process is attached to a Markov chain that gradually adds Gaussian noise to the data. To diffuse the input and output series, the posterior probability of the input series is calculated based on the samples received in prior timestamps of the real series only. Specifically, given the input X=X⁽⁰⁾˜q(X⁽⁰⁾), the approximate posterior q(X^{(1:T)}|X⁽⁰⁾) can be obtained as:

$$q ( {X}^{( 1 : T )} \vert {X}^{( 0 )} ) = {\prod }_{t = 1}^{t} q ( X ( t ) \vert X ( t - 1 ) ) ,$$

$$q ( X ( t ) \vert X ( t - 1 ) ) = N ( X ( t ) ; p √ 1 - β tX ( t ) , β tI )$$

Here, a uniformly increasing hyperparameter (β) is employed to control the level of noise. It is then passed to a bidirectional variational auto-encoder to generate a series closer to the target.

With reference now to an instance-wise contrastive Loss, let i be the index of the input time series sample and t be the timestamp. Then r_{i,t} and r′_{i,t} denote the representations for the same timestamp t but from two augmentations of xᵢ. Ω is the set of timestamps within the overlap of the two subseries, and ¶ is the indicator function. The instance-wise contrastive loss indexed with (i, t) can be formulated as:

$${I}_{inst}^{( i , t )} = - log \frac{exp ( {r}_{i , t} \cdot {r}_{i , t}^{′} )}{\sum {t}_{ϵ Ω}^{′} ( exp ( {r}_{i , t} \cdot {r}_{i , {t}^{′}}^{′} ) + {¶}_{[ t \neq {t}^{′} ]} exp ( {r}_{i , t} \cdot {r}_{i , {t}^{′}}^{′} ) )}$$

In an embodiment, a custom loss function is defined as L₁(y₁\hat{ }, y)+L₁′(y₁\hat{ }, y₁′). Here, L₁ is the mean square error (MSE) between real (y) and target series (y₁\hat{ }) which needs to be minimized. L′ is the contrastive loss between target series and negative samples that needs to be maximized. Similarly, L₂ and L₂′ are the loss functions derived from probabilistic models. Finally, L₃ loss is defined by L₂ norm between y₁\hat{ } and y₂\hat{ }, that is, the loss between synthetic series generated by both the models which needs to be minimized. The custom loss function is thus defined as:

$$Custom Loss = min ( {L}_{1} ) + max ( {L}_{1}^{′} ) + min ( {L}_{2} ) + max ( {L}_{2}^{′} ) + min ( {L}_{3} )$$

### C.2 Noise Addition Block for Non-Seasonal Time Series Data

In a real-world context, it may not be necessary that the time series would be seasonal for the entire period. In this scenario, if the noise is added based on the prior distribution of the real series, there is a good chance that the target series would never come close to the actual data. To prevent this, an embodiment may implement a noise addition block in the encoder-decoder architecture disclosed in FIGS. 1a and 1b. Essentially, the residual blocks may be replaced with the noise addition block as explained below.

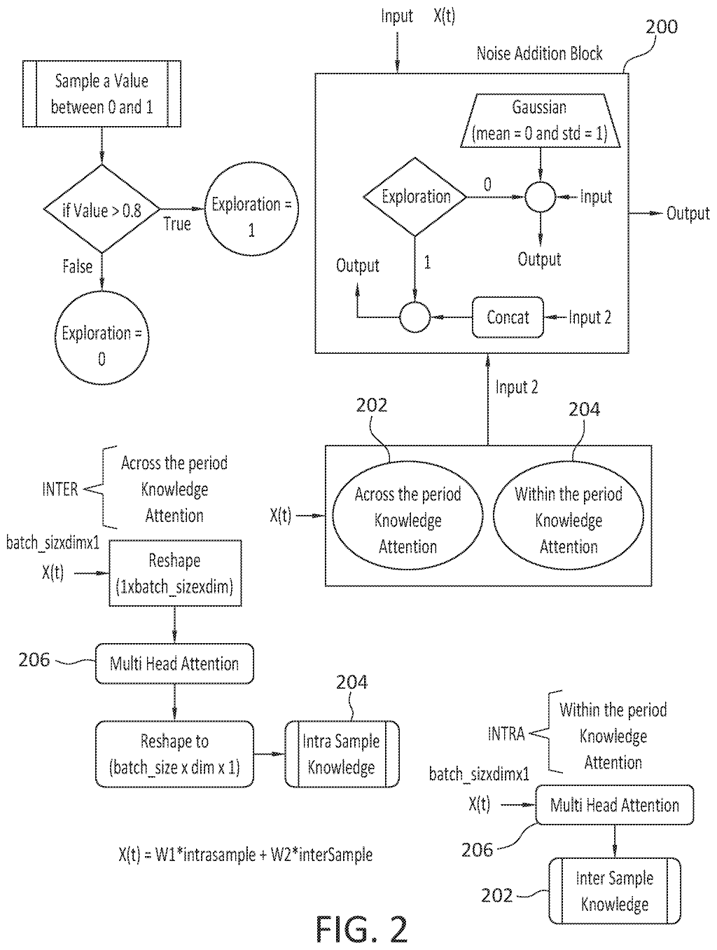

In general, FIG. 2 discloses a noise addition block 200 that may be used for data augmentation, when the actual data is not seasonal, to help ensure that the synthetic data and the real data mimic each other. More particularly, when ‘Exploration’=1 in the noise addition block 200, that is, there is an aim to explore other noise addition techniques for data augmentation, an embodiment may leverage the noise addition framework.

In addition to the normal noise vector, an embodiment may add an additional noise vector derived from multi-head knowledge attention 206. The multi-head attention 206 outputs may comprise a weighted average of two derived outputs viz. inter-sample knowledge 202 and intra-sample knowledge 204. For intra-sample knowledge 204, the same input is taken from different time intervals (batches) and passed to the multi-head attention layer 206. In inter-sample knowledge 202, the same input in the same time interval is passed to the multi head attention layer 206. This technique may help to ensure that the generated, that is, synthetic, target series data is close to the real data even if the real data does not have any seasonality.

### D. Further Discussion

As is apparent from this disclosure, an embodiment of the invention may possess various useful features and aspects, although no embodiment is required to possess any of such features and aspects. Some example features and aspects are discussed hereafter.

An embodiment of the invention may leverage contrastive learning on a hybrid architecture, comprising a probabilistic model and a generative model, to generate synthetic time series samples that are close to the target series. An embodiment may define and implement a custom loss function to maximize the similarities between a real time series of data and a generated, or synthetic, time series of data, and may reduce the bias using an encoder-decoder architecture. In an embodiment, the methodology may be scaled to any time series-based problems at any granular level.

As another example, an embodiment may implement a noise addition framework which helps in data augmentation when the real data does not have definite seasonality. Instead of using regular residual blocks in the encoder-decoder, an embodiment of the invention may leverage inter-sample knowledge, and intra-sample knowledge transfer through a multi-head attention layer. This approach may help to ensure that the target series mimic the real data, instead of simply adding random noise to the real data.

Further, typical approaches to time series analysis only provide better accuracy if the data has clear trend and seasonality. In contrast, an embodiment of the invention may be scaled to any time series data that has combination of IID and Non IID data.

As another example, a conventional approach uses an encoder-decoder architecture with RMSE loss. On the other hand, an example embodiment uses an ensemble that includes a probabilistic model and a generative model with custom loss function for data augmentation. An embodiment may also leverage contrastive learning via instance-wise negative sample generation.

Further, conventional approaches treat seasonal and non-seasonal data in a similar fashion for data augmentation. In contrast, an embodiment of the invention implements a noise addition block specifically for non-seasonal data where adding random noise would never bring the target and real series close, and uses intra-sample and inter-sample knowledge over multi-head attention to generate better samples.

Finally, existing approaches cannot be scaled to multiple use cases involving a combination of data that is both IID (independent and identically distributed) and non-IID. However, an embodiment may scaled to multiple uses cases, and may help in improving forecasting at order or call level by augmenting data series.

### E. Example Methods

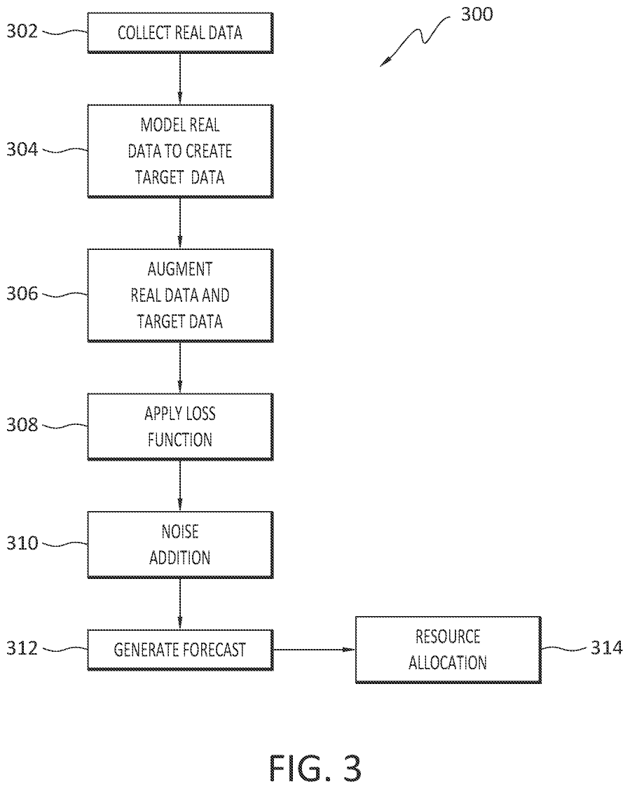

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, a method according to one example embodiment of the invention is referenced at 300. In an embodiment, the method 300 may be implemented in a built-for-the-purpose computing system that may comprise a data generation functionality, and a forecasting functionality.

The example method 300 may begin with the collection 302 of real data. In one embodiment, the real data may comprise, for example, customer order information that was collected over a period of time. Thus, the real data may comprise time series data that forms a time series dataset. The real data may comprise a seasonality component, and/or another component, that does not pervade the entire dataset but is only present in a portion of the dataset.

Next, the real data may be modeled 304, such as with a GAN, so as to create generated, or synthetic, data. The synthetic data may comprise the seasonality, or other, component(s) of the real data. In an embodiment, the amount of data generated by the modeling 304, combined with the real data, may result in a collective dataset having a sufficient amount, and type, of data to support the generation of acceptably accurate forecasts based on the collective dataset.

The real data and the synthetic data may then be augmented 306, possibly synchronously. The augmentation 306 may comprise, for example, the addition of Gaussian noise to the real data and the synthetic data. In an embodiment, the augmentation 306 may be performed using a probabilistic model.

After the real data and the synthetic data have been augmented 306, a loss function may be applied 308 to the real data and the synthetic data. The loss function may be applied 308 in such a way as to minimize the loss, or error, between the real data and the synthetic data. The loss function may thus help to ensure that the synthetic data adequately mimics the real data.

Next, noise may be added 310 to the synthetic data. The addition of the noise may help to ensure that the synthetic data, or target data, is acceptably similar to the real data, even in a case where the real data may lack seasonality. At this point in the method 300, the synthetic data may be adequate to serve, either separately from or in combination with the real data, as a basis for generation of a forecast 312.

Depending upon the outcome of the forecast 312, various actions may be taken. For example, in the context of a customer order application, such action may include allocating 314, or re-allocating 314, resources to ensure that adequate inventory, and/or personnel, are available to support forecasted 312 customer orders.

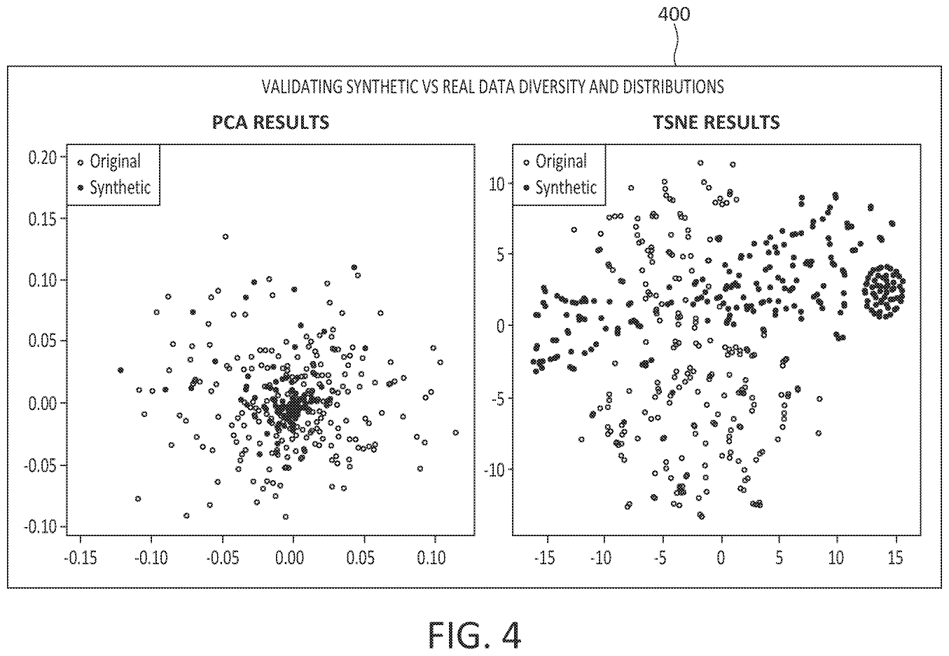

Directing attention briefly to the example of FIG. 4, the two plots 400 disclose the diversity and distribution of real data, versus synthetic data generated by one embodiment of the invention. In particular, the plot on the left discloses results using a PCA (principal component analysis) dimensionality reduction approach, while the plot on the right discloses results using a t-SNE (t-distributed Stochastic Neighbor Embedding) dimensionality reduction approach.

### F. Further Example Embodiments

Following are some further example embodiments of the invention. These are presented only by way of example and are not intended to limit the scope of the invention in any way.

Embodiment 1. A method, comprising: collecting real data; creating synthetic data by modeling the real data; augmenting the real data and the synthetic data; applying a loss function to minimize an error between the real data and the synthetic data; adding noise to the synthetic data to create finalized synthetic data; and generating a forecast based on the finalized synthetic data.

Embodiment 2. The method as recited in any preceding embodiment, wherein the real data comprises time series data that includes a seasonality component that is present in only a subset of the time series data.

Embodiment 3. The method as recited in any preceding embodiment, wherein the synthetic data is created with an ensemble that comprises a generative adversarial network and a diffused probabilistic model.

Embodiment 4. The method as recited in any preceding embodiment, wherein the loss function is a custom loss function that removes bias from the synthetic data.

Embodiment 5. The method as recited in any preceding embodiment, wherein the synthetic data preserves temporal dynamics that are present in the real data.

Embodiment 6. The method as recited in any preceding embodiment, wherein the forecast is used as a basis for performing a resource allocation process, and the resource comprises computing resources and/or human resources.

Embodiment 7. The method as recited in any preceding embodiment, wherein the augmenting comprises adding Gaussian noise.

Embodiment 8. The method as recited in any preceding embodiment, wherein adding noise to the synthetic data helps to ensure that the synthetic data mimics the real data, even when the real data lacks seasonality.

Embodiment 9. The method as recited in any preceding embodiment, wherein the noise is added to non-seasonal data of the synthetic data.

Embodiment 10. The method as recited in any preceding embodiment, wherein the synthetic data is created with a generative adversarial network and a diffused probabilistic model, and a contrastive learning process is applied that minimizes a loss between the generative adversarial network and the diffused probabilistic model to ensure that the synthetic data is bias-free.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

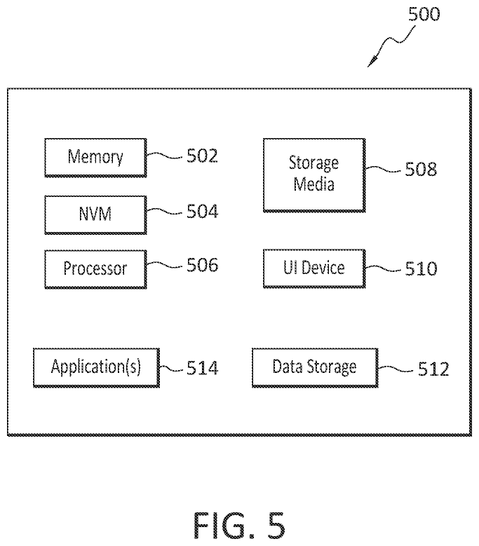

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
collecting real data;
creating synthetic data by modeling the real data;
augmenting the real data and the synthetic data;
applying a loss function to minimize an error between the real data and the synthetic data;
adding noise to the synthetic data to create finalized synthetic data; and
generating a forecast based on the finalized synthetic data.

2. The method as recited in claim 1, wherein the real data comprises time series data that includes a seasonality component that is present in only a subset of the time series data.

3. The method as recited in claim 1, wherein the synthetic data is created with an ensemble that comprises a generative adversarial network and a diffused probabilistic model.

4. The method as recited in claim 1, wherein the loss function is a custom loss function that removes bias from the synthetic data.

5. The method as recited in claim 1, wherein the synthetic data preserves temporal dynamics that are present in the real data.

6. The method as recited in claim 1, wherein the forecast is used as a basis for performing a resource allocation process, and the resource comprises computing resources and/or human resources.

7. The method as recited in claim 1, wherein the augmenting comprises adding Gaussian noise.

8. The method as recited in claim 1, wherein adding noise to the synthetic data helps to ensure that the synthetic data mimics the real data, even when the real data lacks seasonality.

9. The method as recited in claim 1, wherein the noise is added to non-seasonal data of the synthetic data.

10. The method as recited in claim 1, wherein the synthetic data is created with a generative adversarial network and a diffused probabilistic model, and a contrastive learning process is applied that minimizes a loss between the generative adversarial network and the diffused probabilistic model to ensure that the synthetic data is bias-free.

11. A non-transitory storage medium having stored therein instructions that are executable by one or more hardware processors to perform operations comprising:
collecting real data;
creating synthetic data by modeling the real data;
augmenting the real data and the synthetic data;
applying a loss function to minimize an error between the real data and the synthetic data;
adding noise to the synthetic data to create finalized synthetic data; and
generating a forecast based on the finalized synthetic data.

12. The non-transitory storage medium as recited in claim 11, wherein the real data comprises time series data that includes a seasonality component that is present in only a subset of the time series data.

13. The non-transitory storage medium as recited in claim 11, wherein the synthetic data is created with an ensemble that comprises a generative adversarial network and a diffused probabilistic model.

14. The non-transitory storage medium as recited in claim 11, wherein the loss function is a custom loss function that removes bias from the synthetic data.

15. The non-transitory storage medium as recited in claim 11, wherein the synthetic data preserves temporal dynamics that are present in the real data.

16. The non-transitory storage medium as recited in claim 11, wherein the forecast is used as a basis for performing a resource allocation process, and the resource comprises computing resources and/or human resources.

17. The non-transitory storage medium as recited in claim 11, wherein the augmenting comprises adding Gaussian noise.

18. The non-transitory storage medium as recited in claim 11, wherein adding noise to the synthetic data helps to ensure that the synthetic data mimics the real data, even when the real data lacks seasonality.

19. The non-transitory storage medium as recited in claim 11, wherein the noise is added to non-seasonal data of the synthetic data.

20. The non-transitory storage medium as recited in claim 11, wherein the synthetic data is created with a generative adversarial network and a diffused probabilistic model, and a contrastive learning process is applied that minimizes a loss between the generative adversarial network and the diffused probabilistic model to ensure that the synthetic data is bias-free.
